(19) United States
(12) Patent Application Publication
(10) Pub. No.: US 2007/0283589 A1
(43) Pub. Date: Dec. 13, 2007

(54) Template tape with indicia

(76) Inventor: Nicholas C. Garcia, Los Angeles, CA (US)

Correspondence Address: TROJAN LAW OFFICES, 9250 WILSHIRE BLVD, SUITE 325, BEVERLY HILLS, CA, 90212, US

(21) Appl. No.: 11/423,661

(22) Filed: Jun. 12, 2006

(51) Int. Cl. G01B 3/10

(52) U.S. Cl. 33/758

(57) ABSTRACT

The invention comprises a universal template tape for use in construction, home improvement and various crafts. The tape has an adhesive backing, while the non-adhesive side of the tape bears a regularly spaced set of indicia. The indicia include a combination of distance markers perpendicular to the edges off the tape. The indicia further include a grid of regularly spaced parallel lines forming a forty-five degree angle with the edges of the tape. The various embodiments of the universal template tape include combinations of different distance markers and grids.

### BACKGROUND OF THE INVENTION

1. Field of the Invention

The invention relates to the field of construction and craft aids. Specifically, the invention relates to the removable adhesive tapes serving as templates or measuring aids in such applications.

2. Description of the Prior Art

Measuring tapes are well known and widely used in construction, home improvement and various crafts. The tapes have many advantages when compared to rulers. For example, the tapes allow continuous measurement along curved surfaces and around the corners. Further, the tapes have essentially unlimited length, eliminating the need for repetitive measurements and thus minimizing errors and saving time. The measuring tapes may take a form of retractable strips of cloth, plastic or flexible metal. While these devices are durable and reusable, they have several disadvantages. First, the retractable tapes, albeit longer than rulers, are still relatively short. Second, such tapes cannot remain in contact with the surface. Accordingly, the surface must be marked when the measurement is taken. Such marking is not always desirable.

To overcome these drawbacks, a more advanced version of the flexible measuring tape has been developed. This version takes a form of a masking tape pre-marked with indicia. Masking tapes are adhesive, but easily removable and not damaging to the surface to which they adhere. While masking tapes are usually made of paper, a tape used for measurements may be made of a more durable material, which is also resistant to stretching. The measurement scale with various magnitude fractional units maybe printed on the tape. For example, U.S. Pat. Nos. 4,301,596, 4,351,113 and a U.S. Application Publication No. 2005/0257393 disclose tapes that look essentially like rulers. The scale includes consecutive numbers that repeat in certain intervals. Since, unlike a ruler, the tape has no starting point, the scale on the measuring tape must have other landmarks that allow distance measurements. The tapes disclosed in U.S. Pat. Nos. 5,953,826 and 6,067,722 do not use numbers on a scale. Instead, the tapes bear inch marks and a color bands at one-foot intervals. Design Pat. D259,706 and D260,738 combine the two features mentioned above: the tapes bear consecutive numbers but are color coded to indicate certain intervals.

In addition to being a measurement tool, the indicia-bearing masking tapes can also serve as templates. The tapes can be pre-marked with indicia required for various applications in accordance with the industry standards. For example, a tape may bear markings for the insertion of studs in a stud wall. Especially popular are tapes pre-marked with the commonly used 16-inch spacing for studs.

Despite the variety of embodiments described above, the field of template tapes is still lacking in several important aspects. First, the templates are often strictly limited to particular applications. For example, U.S. Pat. No. 5,666,737 discloses a tape with coded markings specifically designed to find the spots for nails, handles and fittings in standard-size furniture. Similarly, U.S. Pat. Nos. 4,149,320 and 4,845,858 disclose a tape with markings for wall studs. The tape in the U.S. Pat. No. 5,107,601 is a mounting template for two-hole fixtures such as towel bars. Finally, the tape in the U.S. Pat. No. 6,511,741 is a roofer's aid marked exclusively for aligning a set of shingles.

Second, the prior art template tapes do not allow measuring angles. This is despite the fact that angles, just like distances, are important for various crafts. Without the aid of a template tape, one must use manual tools such as a protractor, a triangle or a compass to measure angles. As with rulers, the manual approach to measuring angles requires repetitive measurements, is prone to errors and results in undesirable marking of the surfaces.

Finally, the masking tapes are usually made of an easy to tear material. This feature obviates the need for extra tools such as scissors when the tape is laid out. However, an uneven tear can easily damage the indicia and impair measurement.

To address the described drawbacks it would be advantageous to have a versatile template tape with indicia useful for multiple applications. Such a universal template tape would have the indicia of both distances and angles. In addition, the tape would have perforations for easy tearing at predetermined distances.

### SUMMARY OF THE INVENTION

The present invention discloses a template tape for use in a variety of construction, home improvement and craft applications. The tape of the present invention utilizes a base of a standard masking tape or may be made of a more resilient material. The indicia of the tape include various combinations of distance and angle marks. The tape also may have perforations to facilitate neat tearing at set locations. The use of the present invention obviates the need for standard measuring tapes, template tapes as well as angle-measuring tools.

### BRIEF DESCRIPTION OF THE DRAWINGS

FIG. 1 shows a segment of the tape of the first embodiment with a 45-degree-1.5-inch grid.

FIG. 2 shows a segment of the tape of the second embodiment with a variation of a 45-degree-1.5-inch grid.

FIG. 3 shows a segment of the tape of the third embodiment with another variation of a 45-degree-1.5-inch grid.

FIG. 4 shows a segment of the tape of the fourth embodiment with a 45-degree-⅛-inch grid.

FIG. 5 shows a segment of the tape of the fifth embodiment with a 45-degree-½-inch grid.

FIG. 6 shows a segment of the tape of the sixth embodiment with a 45-degree-¼-inch grid.

FIG. 7 shows a segment of the tape of the seventh embodiment with a set of two identical partial 45-degree-¼-inch grids.

FIG. 8 shows a segment of the tape of the eighth embodiment with a set of two different partial 45-degree-¼-inch grids.

FIG. 9 shows a segment of the tape of the ninth embodiment with perforations at each inch mark and a number for each inch cell between the perforations.

FIG. 10 shows a segment of the tape of the tenth embodiment with a number for each inch as well as two sets of angled lines: a 45-degree angled line and a 60-degree angled line.

FIG. 11 shows a segment of the tape of the eleventh embodiment with iterations of a protractor: a set of angled lines spaced ten degrees apart.

FIG. 12 shows a segment of the tape of the twelfth embodiment, which is a seamstress's tape. The tape has a 45-degree ¼ inch grid and a line indicating the center of the tape.

### DETAILED DESCRIPTION OF THE INVENTION

The present invention is a template tape with adhesive backing. The tape has two sides: an adhesive side and a side bearing indicia. The tape may be made out of paper, crepe or any other suitable material having properties described below.

The tape may have adhesive properties and tensile strength of a traditional masking tape, as exemplified by the SCOTCH 3M adhesive masking tape Model 2020. The adhesive reagent allows the tape to be stably affixed to various surfaces, yet be removable without damaging such surfaces. The tensile strength of the tape allows one to easily tear the tape manually. It is noted however, that for some applications it may be desirable that the template tape be permanently affixed to a surface. In such cases a stronger adhesive may be used. Similarly, some applications may require a stronger tape that cannot be easily torn.

FIG. 1 illustrates the first preferred embodiment of the present invention. The tape 1 bears both a distance scale and a 45-degree angle grid. Specifically, the distance scale is placed along a single side of the tape 1. There are two types of markings: the ½-inch mark 2 and a 1-inch mark 3. As a visual aid, mark 3 is made longer than mark 2, so that whole inches could be counted with ease. The angle grid is formed by line segments 4. Line segments 4 form a 45-degree angle with the edges of the tape 1. Line segments 4 originate from the opposing points at both edges of the tape 1 that are spaced at 1.5-inch intervals. Line segments 4 intersect with both edges of tape 1. As a result, a 45-degree 1.5-inch grid is formed.

FIG. 2 illustrates the second preferred embodiment of the present invention. The tape 1 bears both a distance scale and a 45-degree angle grid. The distance scale is placed along both sides of the tape 1. There are three types of markings: the ½-inch mark 2, the 1-inch mark 3 and a ¼-inch mark 5. As a visual aid, the 1-inch mark 3 is made to span the entire width of the tape 1. As another visual aid, mark 5 is made thicker than mark 2. The angle grid is formed by line segments 4 in a way described in reference to FIG. 1.

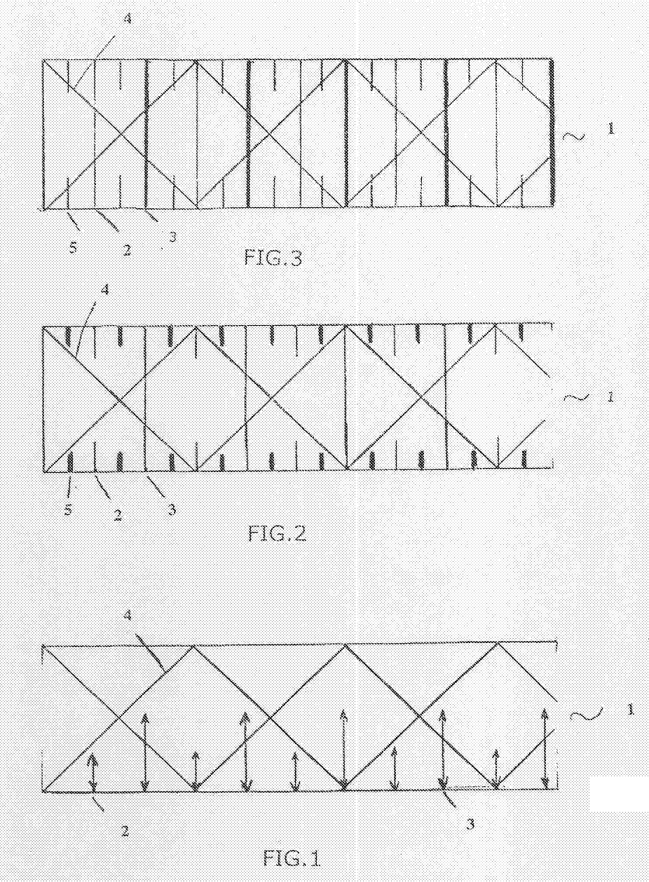

FIG. 3 illustrates the third preferred embodiment of the present invention. The tape 1 bears both a distance scale and a 45-degree angle grid. The distance scale is placed along both sides of the tape 1. There are three types of markings: the ½-inch mark 2, the 1-inch mark 3 and the ¼-inch mark 5. As a visual aid, the 1-inch mark 3 is made to span the entire width of the tape and is made thicker. As another visual aid, mark 2 is also made to span the entire width of the tape 1. The angle grid is formed by line segments 4 in a way described in reference to FIG. 1.

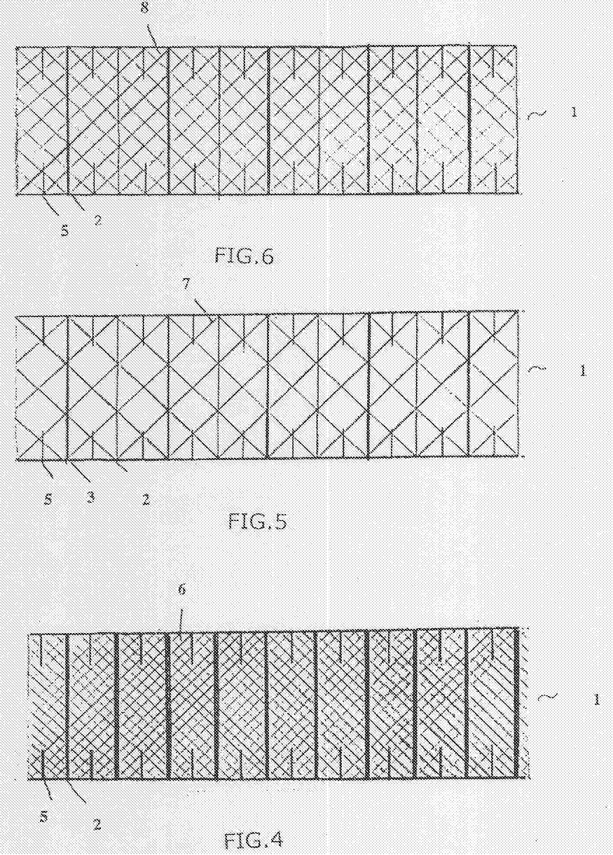

FIG. 4 illustrates the fourth preferred embodiment of the present invention. The tape 1 bears both a distance scale and a 45-degree angle grid. The distance scale is placed along both sides of the tape 1. There are two types of markings: the ½-inch mark 2, and the ¼-inch mark 5. As a visual aid, the ½-inch mark 2 is made to span the entire width of the tape and is made thicker. The angle grid is formed by line segments 6. Line segments 6 form a 45-degree angle with the edges of the tape 1. Line segments 6 originate from the opposing points at both edges of the tape 1 that are spaced at ⅛-inch intervals. Line segments 6 intersect with both edges of tape 1. As a result, a 45-degree ⅛-inch grid is formed.

FIG. 5 illustrates the fifth preferred embodiment of the present invention. The tape 1 bears both a distance scale and a 45-degree angle grid. The distance scale is placed along both sides of the tape 1. The distance marking are as described in reference to FIG. 3. The angle grid is formed by line segments 7. Line segments 7 form a 45-degree angle with the edges of the tape 1. Line segments 7 originate from the opposing points at both edges of the tape 1 that are spaced at ½-inch intervals. Line segments 7 intersect with both edges of tape 1. As a result, a 45-degree ½-inch grid is formed.

FIG. 6 illustrates the sixth preferred embodiment of the present invention. The tape 1 bears both a distance scale and a 45-degree angle grid. The distance scale is placed along both sides of the tape 1. The distance marking are as described in reference to FIG. 3. The angle grid is formed by line segments 8. Line segments 8 form a 45-degree angle with the edges of the tape 1. Line segments 8 originate from the opposing points at both edges of the tape 1 that are spaced at ¼-inch intervals. Line segments 8 intersect with both edges of tape 1. As a result, a 45-degree ¼-inch grid is formed.

FIG. 7 illustrates the seventh preferred embodiment of the present invention. The tape 1 bears both a distance scale and a 45-degree angle grid. The distance scale is placed along both sides of the tape 1. There are two types of markings: the 1-inch mark 3, and the ¼-inch mark 9. Notably, identical marks 9 spaced at ¼ inch intervals replace a combination of visually distinct ½ and ¼-inch marks shown, for example on FIG. 3. Both mark 3 and mark 9 are made to span the entire width of the tape. As a visual aid, mark 3 is made thicker. The angle grid is formed by line segments 10 and 11. Line segments 10 and 11 form a 45-degree angle with the edges of the tape 1. Unlike in the prior embodiments, line segments 10 and 11 do not intersect both edges of the tape 1. Instead, each line segment 10 originates from the either edge of the tape 1 and terminates at the intersection with a distance mark 9 or 3. In turn, the neighboring line segment 11 originates from the point of intersection of line 10 with line 3 or line 2 and terminates at the nearest edge of the tape 1. As a result, a 45-degree ¼-inch grid that is about ¼ inch wide is formed.

FIG. 8 illustrates the eighth preferred embodiment of the present invention. The tape 1 bears both a distance scale and a 45-degree angle grid. The distance scale is placed along both sides of the tape 1. There are two types of markings: the 1-inch mark 3, and the ¼-inch mark 9. As described in relation to FIG. 7, identical marks 9 replace a combination of two types of marks. However in this embodiment marks 9 do not span the entire width of the tape 1. As a visual aid, mark 3 spans the entire width of the tape and is made thicker. The angle grid differs at the two edges of the tape 1. At one edge the grid is formed by line segments 10 and 11 and is identical to the grid described in relation to FIG. 7. At the other edge of the tape 1 the grid is formed by line segments 12 and 13. As line segments 10, line segments 12 start at the edge of the tape 1 and terminate at the intersection with mark 3 or mark 9. However, unlike line segments 10, line segments 12 are spaced at ¼-inch intervals. Similarly, line segments 13 have the same orientation as line segments 11, i.e. originate at the intersection of the neighboring line segment 12 and terminate at the nearest edge of the tape. Line segments 13 are spaced at ¼-inch intervals. As a result, a distinct 45-degree ¼-inch grid that is about ¼ inch wide is formed at each edge of the tape of this embodiment.

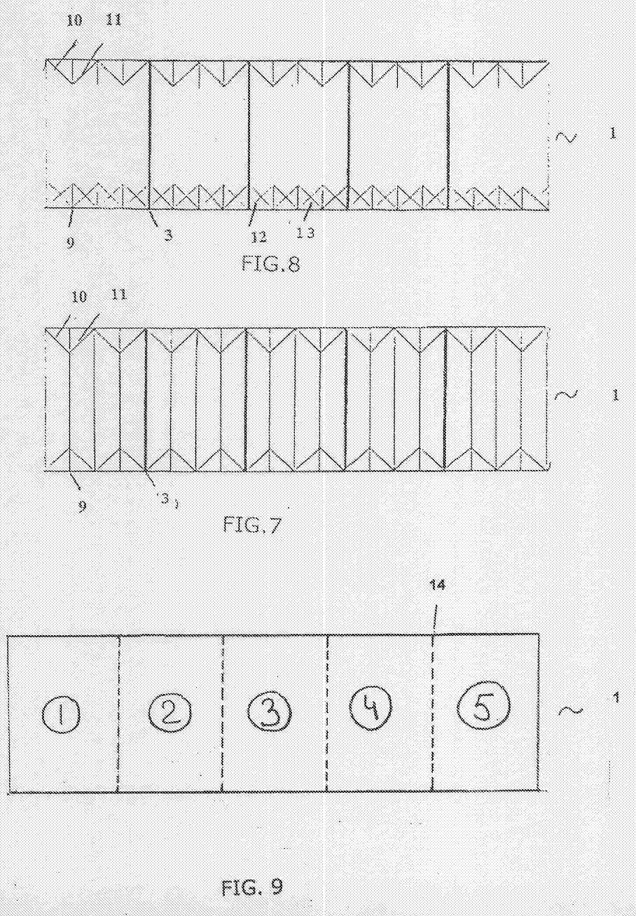

FIG. 9 illustrates the ninth preferred embodiment of the present invention. The tape 1 has perforations 14 for easy tear at each one-inch mark. Each one-inch cell between the perforations bears a number. The numbers may be consecutive or have iterations of, for example, ten or twelve.

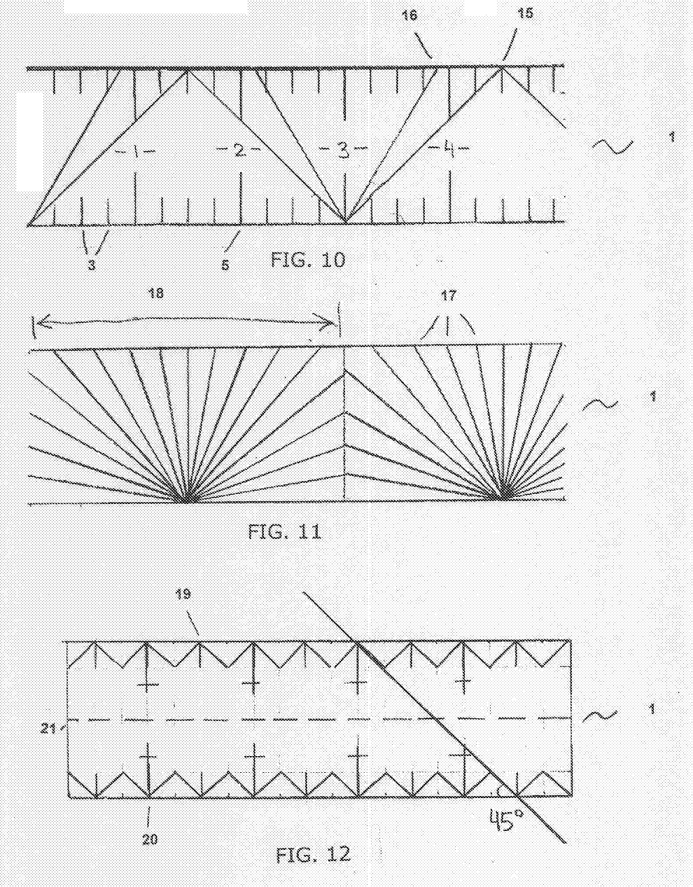

FIG. 10 illustrates the tenth preferred embodiment of the present invention. The tape 1 resembles that of the second preferred embodiment: shorter line segments 3 form ¼-inch marks while the longer line segments 5 form the 1-inch marks. In addition, the tape of this embodiment has two sets of angled lines: the lines 15 angled at 45 degrees to the edge of the tape and lines 16 angled at 60 degrees to the edge of the tape.

FIG. 11 illustrates the eleventh preferred embodiment of the present invention. The tape 1 of this embodiment consists of iterations of protractor segments 18. Each segment comprises a set of angled lines 17 spaced at 10-degree intervals from 0 to 180 degrees with the edge of the tape.

FIG. 12 illustrates the twelfth preferred embodiment of the present invention. This embodiment is a seamstress's tape. The tape 1 has arrows 19 at each ½-inch interval. The tape also has line segments 20 marking each 1-inch interval. Further, the tape has a line 21 marking its middle. Notably, a line following a wing of the arrow would form a 45-degree angle with the edge of the tape.

While the invention has been described in detail with reference to specific embodiments, it will be apparent to one skilled in the art that various modifications can be made within the scope of this invention. Thus the scope of the invention should not be limited by any of the examples described herein but by the claims presented below.

1. An adhesively backed template tape having edges and indicia printed on the non-adhesive surface of the tape, said indicia comprising
a first plurality of parallel line segments intercepting with at least one said edge ata 45 degree angle,
a second plurality of parallel line segments intercepting with at least one said second edge at a 45 degree angle wherein
said first plurality of parallel line segments is perpendicular to said second plurality of parallel line segments, and wherein
each said parallel line segment is spaced at the same interval from each adjacent line segment.

2. (canceled)

3. The template tape of claim 6, wherein said parallel line segments of said third plurality regularly vary in thickness thereby creating a visual aid.

4. (canceled)

5. (canceled)

6. The template tape of claim 1, further comprising a third plurality of parallel lines, perpendicular to said edges of the tape.

7. The template tape of claim 6, further comprising perforations perpendicular to the edge of said tape and spaced at predetermined intervals.

8. (canceled)

9. (canceled)

10. The template tape of claim 1, wherein the line segments of said first and said second pluralitiesintercept both said edges of the tape and intercept so as to form a continuous grid.

11. (canceled)

12. (canceled)

13. (canceled)

14. The template tape of claim 6, further comprising different colors for one or more of the first the second and the third plurality of line segments.

15. The template tape of claim 1, further comprising providing background color for said non-adhesive side of the tape.

16. The template tape of claim 1, wherein said adhesive has adhesion strength of between 12 and 24 ounces.

17. The template tape of claim 6, further comprising numerical indicia associated with said third plurality of parallel lines.

18. The template tape of claim 10, wherein said grid is spaced at a precise interval selected from ⅛, ¼, ½ and 1 inch.

19. The template tape of claim 10, wherein said grid is spaced at a precise interval selected from ½, 1, 1½ and 2 centimeters.
